(19) United States
(12) Patent Application Publication
(10) Pub. No.: US 2021/0176054 A1
(43) Pub. Date: Jun. 10, 2021

(54) PERSONAL INFORMATION VALIDATION AND CONTROL

(71) Applicant: VERIF-Y INC., Philadelphia, PA (US)

(72) Inventors: Ed Adi ZABAR, Gladwyne, PA (US); Chad Evan Peiper, Conshohocken, PA (US); Job John, Philadelphia, PA (US)

(21) Appl. No.: 17/096,939

(22) Filed: Nov. 12, 2020

Related U.S. Application Data
(60) Provisional application No. 62/934,163, filed on Nov. 12, 2019.
(60) Provisional application No. 63/112,555, filed on Nov. 11, 2020.

(51) Int. Cl. H04L 9/08; H04L 9/32

(52) U.S. Cl. CPC H04L 9/0847; H04L 9/0894; H04L 9/3236; H04L 9/0825

(57) ABSTRACT

A method of storing personally identifiable information includes allowing a subject to register with an application, generating private and public encryption keys, requesting and receiving a digital identity from a registrar, validating the personally identifiable information using the digital identity, and storing an encrypted version of the personally identifiable information in a data repository controlled by a subject of the personally identifiable information.

### CROSS-REFERENCE TO RELATED APPLICATIONS

The present application claims the benefit of U.S. provisional patent application No. 62/934,163, filed on Nov. 12, 2019, and U.S. provisional patent application No. 63/112,555, Filed on Nov. 11, 2020, the disclosures of both of which are herewith incorporated by reference in their entireties.

### FIELD OF THE INVENTION

The present invention relates to systems, methods and apparatus for data handling and, more specifically, to systems, methods and apparatus for the secure and private management of identity and credential data.

### SUMMARY

In light of an explosion of unreliable and harmful personally identifiable information, and consequent legislation to control the abuse and spread of the same, the inventors of the present invention have identified a need for a privacy-preserving mechanism for storing, indexing, and retrieving encrypted data in a manner that obviates the ability of the storage provider to view, aggregate, analyze, and monetize the data. In its various aspects and embodiments, the invention improves the portability of application data and its protection from storage provider data breaches. Personal Identifiable Information (PII) is not stored in a centralized storage or database system. PII is securely stored using encrypted data vaults (EDV) where ownership, control, and management of the personal data is assigned to the user/subject of the PII.

Having examined and understood a range of previously available solutions, the inventors named in the present application have developed a new and important understanding of the problems associated with the prior art and, out of this novel understanding, have developed new and useful solutions and improved systems, including solutions and systems yielding surprising and beneficial results.

The invention encompassing these new and useful solutions and improved devices is described below in its various aspects with reference to several exemplary embodiments including a preferred embodiment.

In certain exemplary embodiments, a system and method prepared according to principles of the invention will include the ability to receive PII and validate the PII.

PII can be made self proving by preparing a first combined hash including the substance of the PII along with a unique identifier of an issuing or validating entity.

A further hash of the resulting first combined hash with a unique identifier of the controller of the PII further identifies the resulting doubly hashed record to the PII controller.

In certain embodiments, the present application permits the secure storage of PII in user managed and controlled encrypted data vaults. A privacy layer facilitates the storage and retrieval of user credential records via application programming interfaces (APIs) from data stored on decentralized cloud storage.

For purposes of this disclosure, the term decentralized is intended to convey that control of various storage locations is not exercised by a single entity or person, but by a plurality of different entities and/or persons. This will be distinguished from the term distributed, which implies that data of various types may be stored in a variety of apparatus and/or locations but may or may not be under the control of a single person or entity. Consequently, it will be understood that certain data stores may be both decentralized and distributed, and that distributed organization neither requires nor precludes decentralized control.

According to one deployment topology, encrypted PII is securely stored on mobile devices of the users to which the PII pertains. In further embodiments, mobile device records are synchronized with user encrypted data vaults. To facilitate interoperability, in certain embodiments W3C decentralized identifiers (DIDs), verifiable credentials (VCs), and JSON-LD are applied.

In one embodiment, control of data resides in the subject of the data, rather than in another party. When the subject considers it beneficial to share that data with a contractual counterparty, the system of the invention allows that sharing to proceed in a constrained fashion and under the control of the subject of the PII.

The subject of the PII benefits by being able to share the PII only with selected parties and prevent its general distribution to unauthorized parties. Moreover, the subject of the PII is able to selectively delete elements of the PII, enabling a “right to be forgotten.” In addition, the subject of the PII can monitor the creation and distribution of PII records to ensure that false or defective records are not distributed.

At the same time, the subject of the PII is able to provide validated and reliable PII records to an authorized counterparty for purposes of facilitating a desired transaction.

A Credential and Employment Verification (C&EV) Platform according to principles of the invention facilitates the issuance and verification of educational, work experience, certificates, and license credentials. The C&EV Platform operates on a pluggable extensible architectural framework supporting layered functionality such as compliance screening and self-sovereign identity (SSI) services and standards. The system provides interfaces via a mobile and web applications for credential Holders to interface with their credential wallet, and software as a service (SaaS) dashboards for Issuers. Issuers can also use APIs for credential issuance and registration. In a system according to the invention, users/subjects of PII own and control their data.

### BRIEF DESCRIPTION OF THE DRAWINGS

FIG. 1 shows, in schematic block diagram form, a system according to principles of the invention including features directed to collecting and securing personally identifiable data;

FIG. 2 shows, in schematic block diagram form, a system according to principles of the invention including features directed to collecting and securing personally identifiable data;

FIG. 3 is a diagram showing specific technical features of the invention;

FIG. 4 is a diagram showing specific technical features of the invention;

FIG. 5 is a diagram showing specific technical features of the invention;

FIG. 6 is a diagram showing specific technical features of the invention;

FIG. 7 is a diagram showing specific technical features of the invention;

FIG. 8 is a diagram showing specific technical features of the invention;

FIG. 9 is a diagram showing specific technical features of the invention;

FIG. 10 is a diagram showing specific technical features of the invention;

FIG. 11 is a diagram showing specific technical features of the invention;

FIG. 12 is a diagram showing specific technical features of the invention;

FIG. 13 is a diagram showing specific technical features of the invention;

FIG. 14A is a diagram showing specific technical features of the invention;

FIG. 14B is a diagram showing specific technical features of the invention;

FIG. 15 is a diagram showing specific technical features of the invention;

FIG. 16 is a diagram showing specific technical features of the invention; and

FIG. 17 is a diagram showing specific technical features of the invention.

### DETAILED DESCRIPTION

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention or any entire embodiment thereof. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention.

Correspondingly, references throughout the specification to “one embodiment” or “an embodiment” mean that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

The present invention allows the subject of PII to become the owner and controller of that PII. The invention provides systems, methods and apparatus to provide ownership and control, providing the subject of the PII the opportunity to determine the characteristics of the PII, evaluate and maintain its integrity and validity, and distribute it selectively to contractual counterparties and other entities according to the preferences, desires and judgment of the PII subject. As such, the subject is empowered to apply the PII for commercial or other benefit when the subject determine such application to be advantageous, while preventing applications of the PII that are undesirable.

At the same time, the systems, methods and apparatus of the present invention may serve to relieve other parties, including contractual counterparties and others who might otherwise have held PII to relieve themselves of the costs and potential liability associated with holding the PII of others. In effect, the systems, methods and apparatus of the present invention offer a route to effecting socially desirable reallocations of ownership and control of PII, while facilitating the commercial benefits that derive from providing trusted validation and verification of credentials among parties who are physically or logically remote from one another.

In various embodiments, the present invention achieves the desirable reallocation of control of PII outlined above by providing mechanisms for validating and securing PII embedded in objects that are then maintained in decentralized storage venues, where the specific contents of the storage venues, and access to those venues, are under the exclusive control of the subject of the PII.

Further, in its various embodiments, the present invention allows the subject of the PII to provide limited, and specific technical access to the information of the stored PII objects in a manner that reflects the validation features embodied in the object, assuring the entity receiving that access of the integrity and validity of the PII as originally validated and stored.

As will be described in further detail below, certain embodiments of this invention allow this confirmation of validity and integrity to be achieved by the combination and one-directional hashing of the subject PII along with objects identifying and characterizing certain authoritative entities, such as for example the original issuers of certain credentials embodied in the PII.

It will be appreciated by one of skill in the art that available hashing and encryption technologies, along with the novel systems methods and apparatus, allow the preparation of PII objects that are effectively impervious to decryption and/or corruption, and to other attempts to hijack the validation features of the stored object. In addition, among other embodiments, certain embodiments of the present invention will include the storage of certain access parameters in substantially immutable and public repositories that serve to further evidence the validity and reliability of the stored information. In certain exemplary embodiments, such storage will include centrally managed public data repositories. In further aspect of certain exemplary embodiments, storage facilities incorporate distributed and/or decentralized blockchain repositories.

As is known, certain blockchain architectures provide data integration based on redundant, reentrant and encryption features that make manipulation or other corruption of data within the blockchain impractical in light of the extraordinary computational resources that would be required to achieve such an outcome. Consequently, storage of the indicated access parameters in the blockchain repository, discrete from storage of the validated PII object, can be beneficial.

In light of the foregoing, a variety of exemplary embodiments are presented herewith.

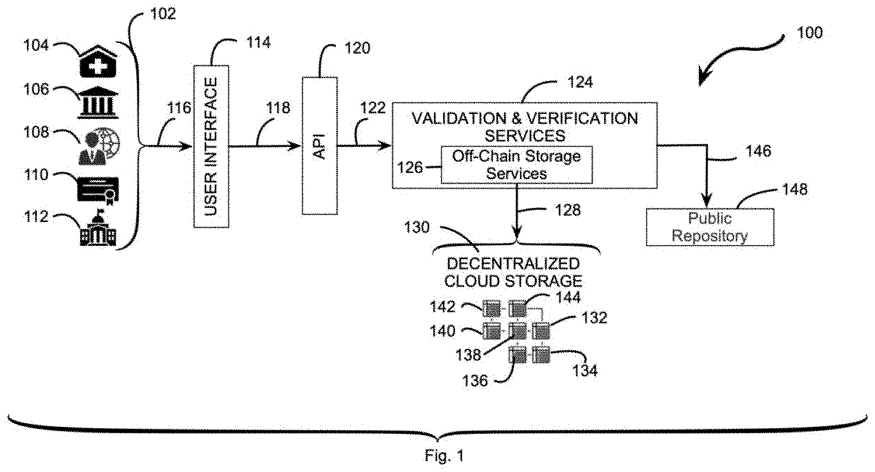

FIG. 1 shows, in schematic block diagram form, certain aspects of an exemplary PII management and control system 100 prepared, according to principles of the invention, for subject owned, controlled, and managed PII data. In the illustrated management and control system 100, certain PII originates with an entity or institution 102 with which a subject has interacted. Such an entity or institution might be, for example, a medical provider or hospital 104, a court or other judicial or government administrative entity 106, an employer, customer or vendor 108, an educational institution 110, or any other private or governmental institution or entity, 112.

As indicated, the entity or institution 102 is provided by the PII management and control system 100 with an interface 114, such as a user interface, at which relevant PII pertaining to the subject can be entered 116 into the system. The interface 114 encodes the entered data, corresponding to the PII, and transfers it 118 to a secure application programming interface (API) 120. The API 120 receives the encoded PII data and transfers it securely 122 to a validation and verification services portion 124 of the system.

As will be further discussed below, the validation and verification portion 124 of the system validates and encrypts the PII in a manner that uniquely and immutably identifies the PII data to the entity or institution 102 from which it originates, as well as to the subject of the PII, producing a PII data object. The resulting object is thus validated as, for example, a credential of the subject, and (in certain applications) as an element of a digital identity of the subject.

In the illustrated exemplary embodiment the validation and verification services portion 124 of the system includes an off-chain storage services portion 126 that provides an interface 128 to, for example, a decentralized cloud storage system or mechanism 130.

The decentralized cloud storage system 130 is arranged and configured such that the off change storage services portion 126 of the system 100 is arranged and configured to store the validated and encrypted PII object of an individual in a unique memory storage location e.g., 132 of the decentralized cloud storage 130, where the unique memory storage location e.g., 132, 134, 136, 138, 140, 142, 144 is specified, controlled, and in certain instances owned, by the subject of the PII.

In certain embodiments of the invention, and as discussed in additional detail below, concurrently with storage of the PII data object in a location, e.g. 132, of decentralized cloud storage 130, a unique identifier related to that PII data object is created by the validation and verification services portion 124 of the system 100 and stored 146 in a public repository 148. In certain embodiments of the invention, the unique identifier is encrypted. In still further embodiments of the invention, the public repository is configured and adapted to ensure immutability of the unique identifier. In certain of these embodiments of the invention, the public repository 148 includes a storage system or storage features having blockchain characteristics.

On viewing the illustration of FIG. 1, one of skill in the art will appreciate that any one or more of the unique memory storage locations 132-144 will be specified, controlled (and owned) by one individual subject, whereas others of the unique memory storage locations 132-144, accessible for storage purposes by the decentralized cloud storage 130, will be specified, controlled (and owned) by another PII subject. Likewise, it will be appreciated that the public repository may include a plurality of unique identifiers related to a corresponding plurality of PII subjects and/or a corresponding plurality of PII objects respectively.

It will also be appreciated by one of skill in the art that, in certain alternative embodiments, storage of the PII data object is effected in an encrypted data vault, where secure access to individual storage locations is provided to the subject of the PII data as a service. In such an embodiment, the encrypted data vault offers discrete and independent access to memory storage locations functionally corresponding (for purposes of the present discussion) to e.g. memory storage location 132. In such embodiments, the subject of the PII controls encryption of the data object and secure access to the data storage location. Consequently, the subject of the PII is also the owner and controller of the PII data object, having the ability to prevent dissemination of the PII data and/or control access to such data by specific and selected individual entities.

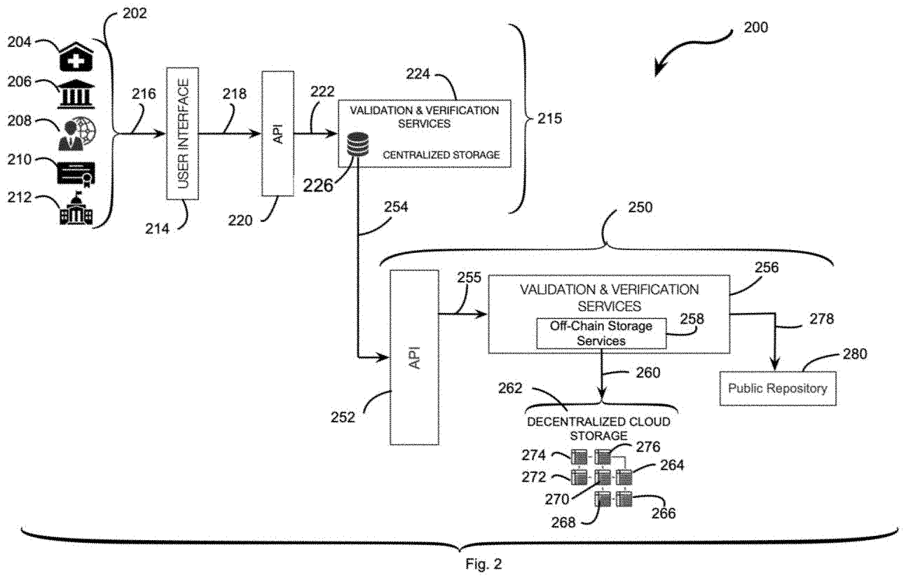

FIG. 2 shows, in schematic block diagram form, certain further aspects of an exemplary PII management and control system 200. Upon examination of FIG. 2 one of skill in the art will appreciate that the system 200 provides a mechanism for receiving PII previously stored and collected in a conventional centralized storage system. The PII thus received is processed by the PII management and control system 200 so as to render a resulting PII data object under the ownership and control of the subject of the PII. Generally speaking, as a part of this processing, the corresponding PII originally stored in the conventional centralized storage system is deleted and eradicated.

Consistent with such an arrangement certain PII originates with an entity or institution 202 with which a subject has interacted. Such an entity or institution might be, for example, a medical provider or hospital 204, a court or other judicial or government administrative entity 206, an employer, customer or vendor 208, an educational institution 210, or any other private or governmental institution, 212.

The PII may have been received, for example, into a conventional centralized data storage system 215, through a conventional secure user interface 214 at which relevant PH pertaining to the subject is entered 216 into the conventional system 215. The interface 214 encodes the entered data, corresponding to the PII, and transfers it 218 to an API 220. The API 220 receives the encoded PII data and transfers it 222 to a validation and verification services portion 224 of the conventional system 215.

The validation and verification services portion 224 of the conventional system 215 processes the PII in whatever manner is determined by the designers of that system 215, and stores the data in a centralized data storage repository 226 under the control of the conventional system 215.

The reader will appreciate that the details of structure and operation of the conventional system 215 presented above are merely exemplary and may have any number of different arrangements according to pre-existing practices and conditions. The examples provided are merely to illustrate the conventional gathering of PII data, and its storage in a centralized data repository under the control of the conventional system 215 and its operators and owners.

As further shown in FIG. 2, system 200 includes specific, novel and inventive features 250 of a processing system 200 prepared according to principles of the invention. Among others, these features 250 include a secure API 252. The API 252 receives 254 PII data related to a particular PII subject through a secure communication channel from the centralized data store 226 of the conventional system 215.

In a manner similar to that discussed above in relation to the features illustrated in FIG. 1 the API 252 transfers 255 the received PII to a validation and verification services portion 256 of the system. In certain embodiments of the invention, the data received 254 from the conventional system 215 will include, in addition to the PII data, validating information confirming the origin of the PII data element.

As will be further discussed below, the validation and verification portion 256 of the system validates and encrypts the PII in a manner that uniquely and immutably identifies the PII data to the entity or institution 202 from which it originates, as well as to the subject of the PII, producing a PII data object. The resulting object is thus validated as, for example, a credential of the subject, and (in certain applications) as an element of a digital identity of the subject.

In the illustrated exemplary embodiment the validation and verification services portion 256 of the system includes an off-chain storage services portion 258 that provides an interface 260 to, for example, a decentralized cloud storage system or mechanism 262.

The decentralized cloud storage system 262 is arranged and configured such that the off-chain storage services portion 258 of the system 200 is arranged and configured to store the validated and encrypted PII object of an individual in a unique memory storage location, e.g., 264 of the decentralized cloud storage 262, where the unique memory storage location e.g., 264, 266, 268, 270, 272, 274, 276 is specified, controlled, and in certain instances owned, by the subject of the PII.

Again, in a manner analogous to the system of FIG. 1, in certain embodiments of the invention, and as discussed in additional detail below, concurrently with storage of the PII data object in a location, e.g. 264, of decentralized cloud storage 262, a unique identifier related to that PII data object is created by the validation and verification services portion 256 of the system 200 and stored 278 in a public repository 280. In certain embodiments of the invention, the unique identifier is encrypted. In still further embodiments of the invention, the public repository is configured and adapted to ensure immutability of the unique identifier. In certain of these embodiments of the invention the public repository 280 includes a storage system or storage features having blockchain characteristics.

As with the system of FIG. 1, one of skill in the art will appreciate that any one or more of the unique memory storage locations e.g., 264-276 will be specified, controlled (and owned) by one individual subject, whereas others of the unique memory storage locations 264-276, accessible for storage purposes by the decentralized cloud storage 258, will be specified, controlled (and owned) by another PII subject. Likewise, it will be appreciated that the public repository may include a plurality of unique identifiers related to a corresponding plurality of PII subjects and/or a corresponding plurality of PII objects respectively.

It will also be appreciated by one of skill in the art that, in certain alternative embodiments, storage of the PII data object is effected in an encrypted data vault, where secure access to individual storage locations is provided to the subject of the PII data as a service. In such an embodiment, the encrypted data vault offers discrete and independent access to memory storage locations functionally corresponding (for purposes of the present discussion) to, e.g., memory storage location 264. In such embodiments, the subject of the PII controls encryption of the data object and secure access to the data storage location. Consequently, the subject of the PII is also the owner and controller of the PII data object, having the ability to prevent dissemination of the PII data and/or control access to such data by specific and selected individual entities.

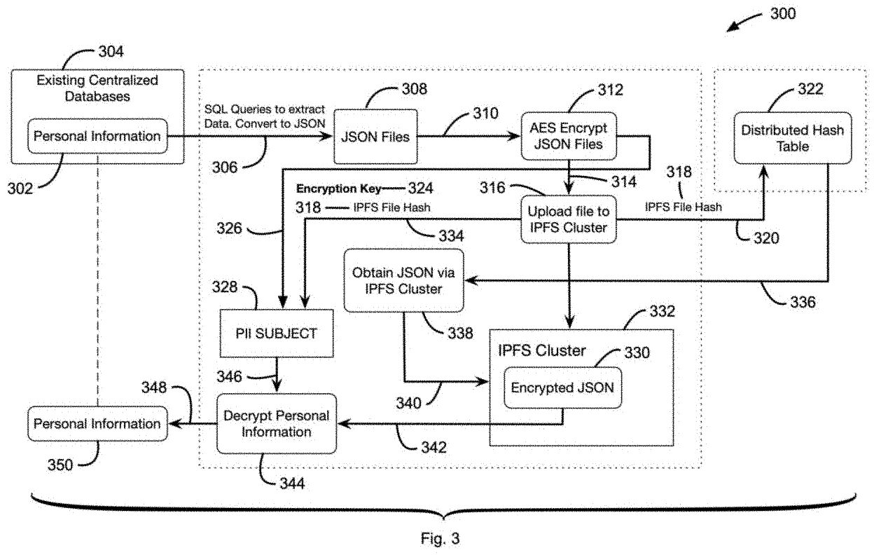

FIG. 3 shows, in schematic block diagram form, additional specific technical features of a system and method 300 according to principles of the invention. By way of overview, one of skill in the art will appreciate that the features of the system 300 represent processes and apparatus for the receipt, validation, storage and retrieval of PII. In certain embodiments, these features are consistent with the system 200 described above in relation to, e.g., FIG. 2, and accordingly in relation to the system 100 of FIG. 1. It will be understood, however, that the features of system 300 will also be applied in alternative embodiments and systems independent of systems 100 and 200.

As with the system 200 of FIG. 2, in the exemplary embodiment of FIG. 3, conventionally stored PII 302 is present in an existing centralized database 304. In response to an SQL query 306 a data item representing PII is retrieved from the centralized database 304 and received, validated and stored 308 in a JSON file format within a transient memory facility of the system 300. The PII in the JSON file is then further processed 310 by the application of an AES encryption procedure 312. The AES encryption procedure 312 produces an encrypted JSON file for storage in a decentralized and/or distributed file system. In certain embodiments of the invention, the JSON file is stored in an Inter Planetary File System (IPFS) protocol file system.

According to certain aspects of the invention, AES encryption 312 will be performed employing a public key associated with the subject of the PII in question. In certain implementations of the invention, the public key is produced as part of a public key/private key pair by the system of the present invention. The public key is then used for the encryption described above and (optionally) stored in a public repository. The private key 324 is provided 326 to the subject 328 of the PII, thereby effectively transferring control of the PII to the subject of the PII.

In other embodiments, the system of the present invention receives (or retrieves from a public repository) a public key prepared in advance by, or on behalf of, for example, the subject of the PII, and correspondingly employs that public key in AES encryption 312.

In certain aspects and embodiments of the invention, and with further reference to FIGS. 1 and 2, the PII data object is combined with a validation data object of an originating institution or entity 102, 202 prior to AES encryption. The presence of this validation data object along with the PII data serves to validate the authenticity of the PII data upon decryption.

In other embodiments of the invention, AES encryption of the PII is performed prior to combination of the encrypted PII with the validation data object. Thereafter, a further encryption of the combined data objects is performed to produce a doubly encrypted data object.

In certain embodiments, a public key of the originating institution or entity 102, 202 will be used to encrypt the PII prior to (or re-encrypt the PII after) AES encryption 312. Access to a corresponding private key of the institution or entity will allow decryption (with respect to this phase of encryption) of the PII, and therefore validation of the authenticity of the PII data object.

As is known in the art, IPFS is a protocol and peer-to-peer networks for storing and sharing data in a distributive file system. IPFS uses content-addressing to uniquely identify each line in a global namespace connecting multiple computer devices. Unlike a single centrally controlled computer, IPFS is built around a cooperative system of user-operators holding a portion of the overall data, creating a resilient and robust data storage system. Any user on the network can serve a file by its content address, and other peers in the network can find and request that content from any node storing the content. In retrieving content, the content address is resolved based on a distributed hash table.

Also as known in the art, a distributed hash table is a distributed system that provides a resolution and lookup service similar to or including a hash table. In such a table, key-value pairs are stored, and any participating node can efficiently retrieve the key value associated with a given key. Distribution of the hash table among multiple nodes provides robustness, and evaluation of the key allows the location and retrieval of specific data.

Referring again to FIG. 3, the encrypted JSON file is received for processing by a process 316 that produces an IPFS file hash 318 for storage 320 in the IPFS distributed hash table system 322. As will be further discussed below, in certain embodiments, the functionality of the distributed hash table 322 will be embodied in a blockchain database.

Process 316 concurrently stores the previously encrypted JSON file 330 at the corresponding location in the IPFS cluster 332, in a manner consistent with the distributed hash table. Accordingly, IPFS file hash 318 is uniquely associated with a location of the encrypted JSON file 330 in the IPFS cluster 332. In addition, the IPFS file hash 318 is provided 334 to the PII subject 328. As noted above, possession of the IPFS file hash 318 allows retrieval of the encrypted JSON file 330 by resolution of the IPFS file hash 318 against a distributed hash table 322, consistent with IPFS protocols.

One of skill in the art will appreciate that preparation of the IPFS hash key is a one-directional hashing process and that, while one in possession of the hash key can readily find the corresponding PII data object stored in the IPFS distributed storage system, the key itself is unintelligible. Consequently, in the absence of the key, one cannot locate or identify the IPFS record corresponding to the PII data object by any practical decryption of the distributed hash table. It will also be appreciated by one of skill in the art that the use of an IPFS protocol system, of AES encryption, and of the JSON file format are merely exemplary of a variety of other systems. Such other systems will become apparent to one of skill in the art as possible alternatives once apprised of the particular aspects and details of the invention presented herewith.

In light of the foregoing, it will be clear that the PII subject 328, having possession of the encryption key 3324 and IPFS file hash 318 is therefore able to access (and control access to) the PII stored in the distributed file system of the IPFS cluster 332. In addition, the PII subject is empowered to grant access to the PH to others according to the wishes and objectives of the PII subject.

This retrieval process is also illustrated in FIG. 3. Presentation of the IPFS file hash 318 to the distributed hash table 322 by the PII subject (or his or her agent or permittee), is resolved by the hash table 322 to produce IPFS protocol address information specifying the location of the corresponding encrypted JSON file 330 bearing the PII data object. This IPFS protocol address information is received 336 by the IPFS system 338 and the encrypted JSON file 330 is returned 342 to a decryption process 344. The decryption process 344 also receives 346 the private key 324 directly or indirectly from the PII subject. Accordingly, the decryption process 344 produces 348 a decrypted version of the underlying PII 350/302 as previously stored.

In certain embodiments of the invention, as discussed in more detail below, rather than direct receipt by the PII subject of the IPFS file hash, the IPFS file hash will be stored in, e.g., a distributed database and a transaction ID will be returned to the subject of the PII in its place. In such an embodiment, the subject of the PII, or his or her agent or permittee, will recover the IPFS file hash using the transaction ID to locate the IPFS file hash in the distributed database. In certain embodiments, the distributed database will be a blockchain-based database.

It will be appreciated that where additional layers of encryption have been added (as described above) by, for example, the co-encryption of PII with validation data from a validating institution or entity (e.g., 102, 202), additional decryption will be undertaken for validation purposes.

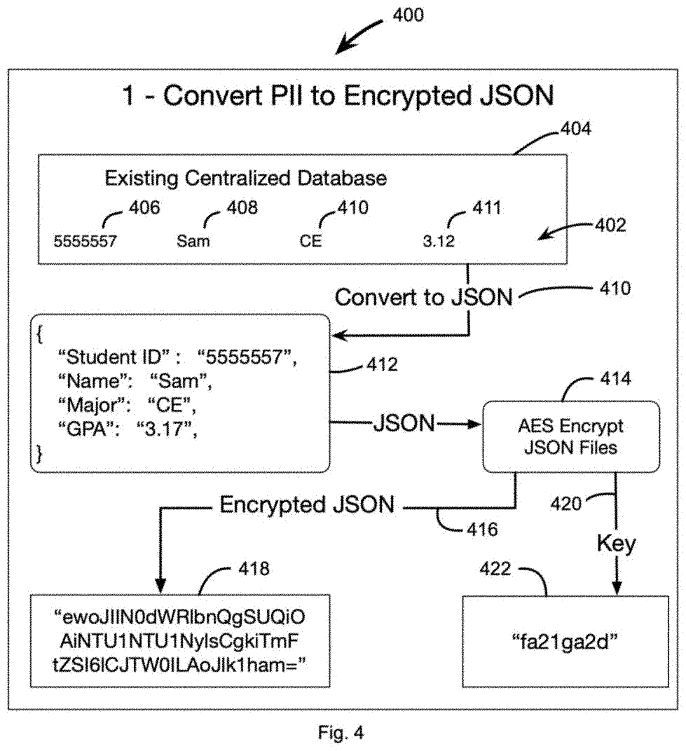

With further reference to FIG. 3, and now with reference to FIGS. 4-6, the practitioner of ordinary skill in the art will perceive further specific technical details illuminating exemplary data structures, processes and results pertaining to process 300 as outlined above. FIG. 4 illustrates data and processes 400 including exemplary PII as initially stored within record 402 of a pre-existing centralized database 404. PII record 402 includes, for example, a subject identification number 406, a subject name 408, a status indicator 410 such as, e.g., an academic major, and an exemplary subject characteristic 411 such as, e.g., a grade-point average.

Consistent with system and method 300, the PII data of record 402 is converted 410 to, e.g., a JSON file 412. The JSON file is thereafter encrypted 414 by, e.g., AES encryption to produce 416 an encrypted JSON file 418. The exemplary AES encryption process 414 also produces 420 an encryption key 422. As discussed above, in certain embodiments, this encryption key 422 is provided to, or otherwise placed under the control of, the subject of the PII.

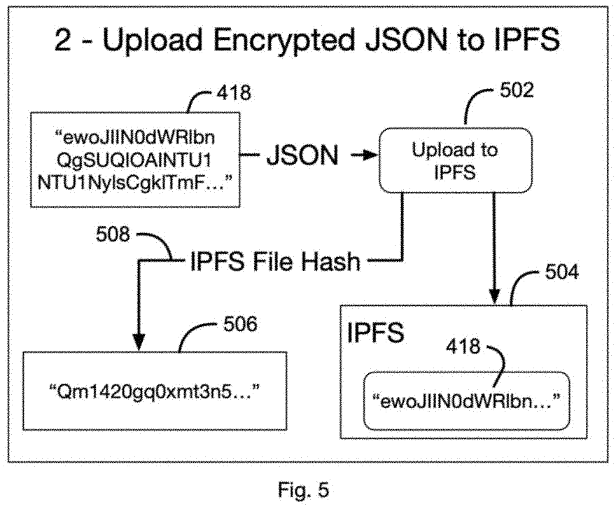

With further reference to FIG. 3, FIG. 5 shows that the encrypted JSON file 418 is then uploaded 502 to, e.g., a decentralized distributed IPFS protocol cluster 504 (corresponding, in certain embodiments, to cluster 332 of FIG. 3). Thus, one sees that the encrypted JSON file 418 is stored within the IPS cluster 504. It will be appreciated of course that, notwithstanding this schematic representation, encrypted JSON file 418 may or may not (according to a particular implementation) be sharded and otherwise distributed over a wide variety of physical locations and/or apparatus within the IPFS cluster.

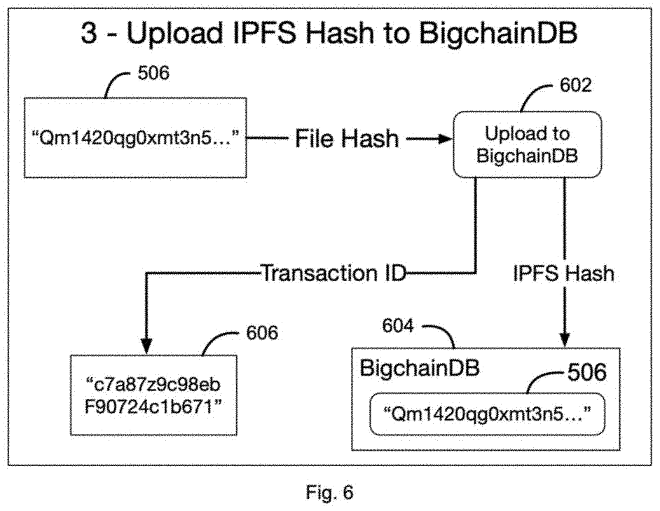

Concurrently with storage of the encrypted JSON file 418 on the IPFS cluster, an IPFS file hash 506 is produced 508. Referring now to FIG. 6, IPFS file hash 506 is uploaded 602 to a public repository database 604 (illustrated, e.g., here as a BigchainDB database). One of ordinary skill will understand that BigchainDB™ is a a particular example of a blockchain-based database, as known in the art. Accordingly, it will be appreciated by one of ordinary skill in the art that any of a variety of other databases and distributed hash table implementations will offer various characteristics and attributes that may be desirable in a particular implementation of the present invention. Accordingly, alternative storage arrangements for the IPFS file hash will be made in corresponding embodiments of the invention.

With the foregoing in mind, one sees that concurrently with storage of the IPFS file hash 506 in BigchainDB 604, a transaction ID 606 is produced. Consistent with the discussion above, in certain embodiments of the invention, this transaction ID 606 is returned to the subject of the PII, thereby conveying to that subject effective control over access to the underlying encrypted IPFS file.

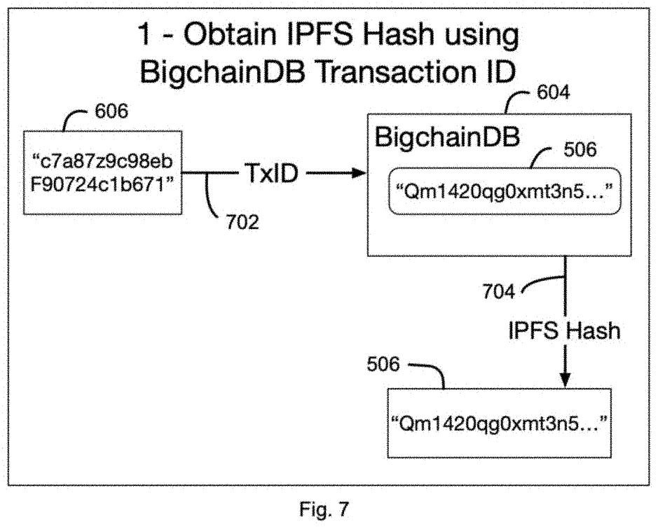

Making further reference to FIG. 3, and now with reference to FIGS. 7-10, the practitioner of ordinary skill in the art will perceive further specific technical details illuminating exemplary data structures, processes and results pertaining to process 300 as outlined above. FIGS. 7-10 illustrate retrieval of the PII from storage in the IPFS cluster. Specifically, FIG. 7 shows the transaction ID 606 previously provided to the subject of the PII. The subject of the PII, or his or her agent or permittee, can present 702 this transaction ID to the BigchainDB database 604 to locate and retrieve 704 the previously prepared IPFS file hash 506 from the BigchainDB database 604.

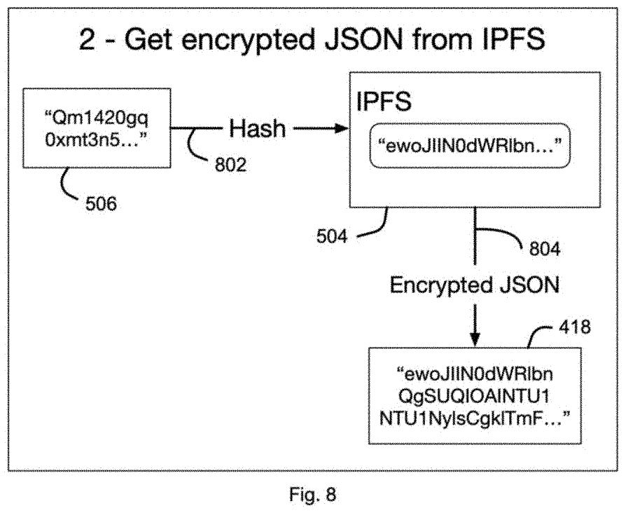

Referring now to FIG. 8, the IPFS file hash 506 is presented 802 to the IPFS cluster 504 to retrieve 804 the encrypted JSON file 418.

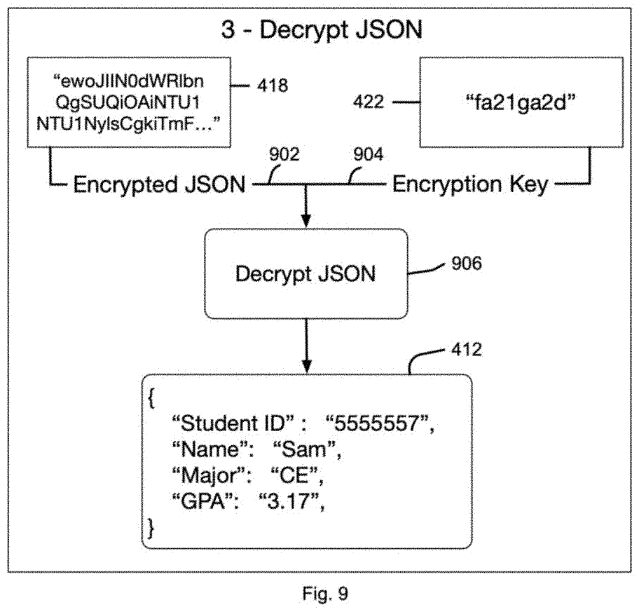

Referring to FIG. 9, the encrypted JSON file 418 is received 902 for decryption from the IPFS cluster. The encryption key 422 is received 904 from the PII subject, his or her agent or permittee. Having these two elements, the system is then able to decrypt 906 the encrypted JSON file to reveal the PII 412 as originally stored.

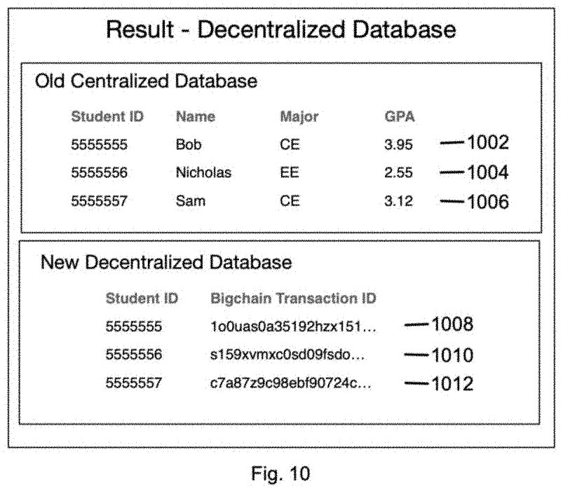

FIG. 10 shows the contrasting storage modalities of the conventional system and the present invention, including, e.g., a plurality of individual student records 1002, 1004, 1006 as originally received from a centralized database 404, and the relation of, for example, student IDs and BigchainDB transaction identifiers (IDs) 1008, 1010, 1012 respectively.

In certain further aspects and embodiments, the invention provides for verification and validation of the PII as referenced, e.g., at FIG. 2 validation and verification services 256. It will be appreciated that various parties, including entities and individuals, will be subject to validation in the course of various applications of the invention.

As context, it should be noted that a Globally Unique User Identification (GUID) is a number used to identify an individual or data element. Although there is a small probability of application, when generated according to standard methods, as known in the art, GUIDs are effectively unique.

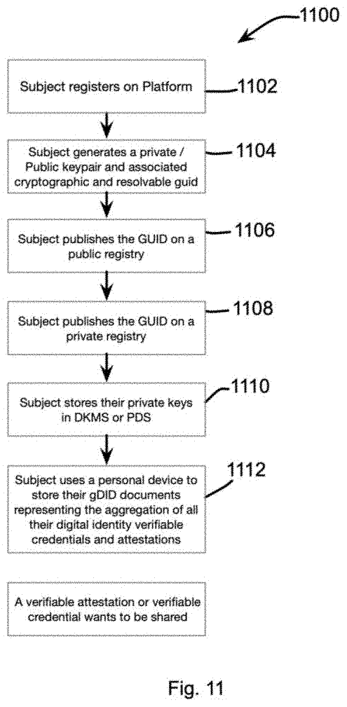

Referring, now, to FIG. 2, and making further reference to FIG. 11, in certain embodiments of the invention a process 1100 for validation of an individual or entity will include registration by the individual, or by a representative of the entity, with the system/platform of the invention 1102.

Thereafter 1104, in one mode of operation, the registering individual or representative presents a previously prepared Globally Unique Identification Document (GUID) along with a previously prepared private/public encryption key pair the system/platform. In an alternative mode of operation, the system/platform generates one or both of the GUID and private/public encryption key pair associated with and for use by the individual or entity.

The subject publishes 1106 the GUID on a public registry.

The subject publishes 1108 the GUID on a private registry.

The subject stores 1110 the private encryption key in a key management facility such as, e.g., DKMS or PDS, as known in the art. Thereafter, the subject uses a personal device such as, e.g., a tablet, a smart phone, a desktop computer, etc., or an encrypted data vault, to store 1112 GDID documents produced by the system. The GDID documents represent and aggregation of digital identity documents and verifiable credentials, along with attestations, related to the individual or entity.

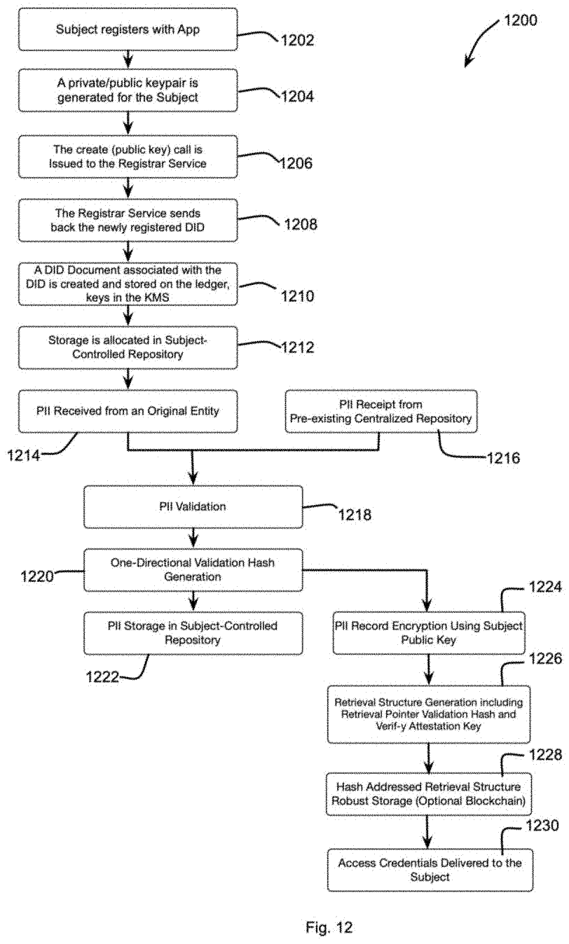

FIG. 12 further illuminates a process 1200, similar to process 1100 of FIG. 11. As shown. The process 1200 includes the step of subject registering with an app 1202. In light of the foregoing discussion, one of skill in the art will appreciate that the subject may be, e.g., an individual or an entity.

At step 1204 a private/public key pair is generated for the subject. As shown in step 1206, a create (public key) function call is issued to a registrar service. At step 1208, the registrar service returns a newly registered Digital Identity Document (DID). One of skill in the art will appreciate that DID's provide characteristics of being decentralized, persistent, cryptographically verifiable, and resolvable. Accordingly, they are valuable in the present context for validation of PII.

At step 1210 A further DID document is associated with the above-newly created DID and stored on a ledger keys. Simultaneously, encryption keys associated with the DID are stored in a key management system.

At step 1212, storage is allocated in a Subject Control Repository. The subject control repository can be any appropriate device or memory, whether local or cloud-based, that exists under the control of the subject.

Thereafter, either PII is received 1214 from an original entity (e.g., 102) issuing a credential, or PII is received 1216 from a pre-existing centralized repository.

PII is received and validation is applied to the PII 1218. Thereafter the PII is subjected to a one directional validation hash 1220. The resulting document is thereafter either stored in a repository controlled by the subject of the PII 1222, or is further encrypted 1224 using the public key of the subject of the PII.

The encrypted document is thereafter submitted for storage and a retrieval structure is generated 1226 including a retrieval pointer, validation hash, and verify attestation key.

The retrieval structure is hash-addressed 1228 onto a robust storage medium such as, for example, and encrypted data vault or a block chain.

Thereafter, access credentials are delivered 1230 to the subject of the PII.

In certain embodiments, the validation process further includes the application of algorithmic search procedures to identify characteristics of an entity or individual based on public records including corporate records databased and made available by secretaries of State, social media outlets, and other online credentialing materials.

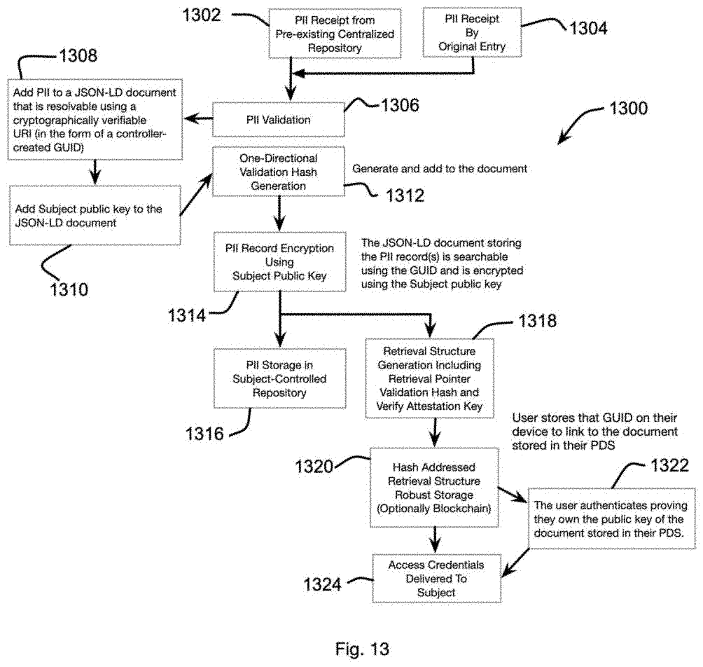

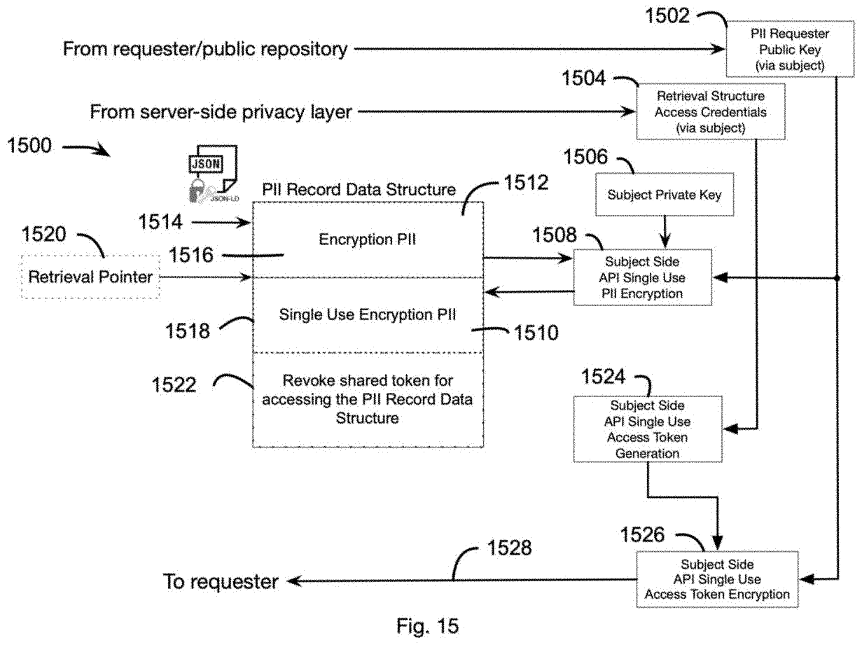

FIG. 13 and FIG. 15 show, in schematic flowchart form, further aspects and specific technical details of processes for storage and retrieval respectively of PII according to principles of the invention. It will be evident to one of skill in the art that these figures provide additional detail with respect to the previously provided embodiments, and that they can also be implemented independently in other embodiments not yet discussed.

Accordingly, FIG. 13 shows a process and system 1300 for storing PII under the control of a subject of the PII. The system 1300 includes at least one of receiving PII 1302 from a pre-existing centralized repository, and receiving PII directly from an issuing individual, entity or institution 1304. Upon receipt, the PII is validated 1306. The validated PII is thereafter 1308 added to a JSON-LD document that is resolvable using a cryptographically verifiable URI (in the form of a controller-created GUID). Thereafter a public key of the subject of the PII is added to the JSON-LD document 1310.

The resulting JSON-LD document is processed 1312 to generate a one-directional validation hash, which is added to the JSON-LD document. Thereafter, the JSON-LD document is further encrypted 1314 using a public key of the PII subject. The encrypted JSON-LD document is then stored 1316 in a subject -controlled repository. The encrypted JSON-LD document is searchable using the GUID of step 1308.

Concurrently with storage of the encrypted JSON-LD document, a retrieval structure is generated 1318 including a retrieval pointer, a validation hash and a verify attestation key. The resulting retrieval structure is stored 1320 a robust storage system. In certain embodiments, this robust storage system includes a blockchain. In certain embodiments, the subject of the PII stores the GUID on a personal device, such as, e.g., a smart phone, and thereby retains a link to the document stored in their Personal Data System (PDS).

Thereafter, the user can authenticate data 1322 by demonstrating that they own the public key of the document stored in their PDS. In this manner, access credentials are delivered to the subject of the PII 1324.

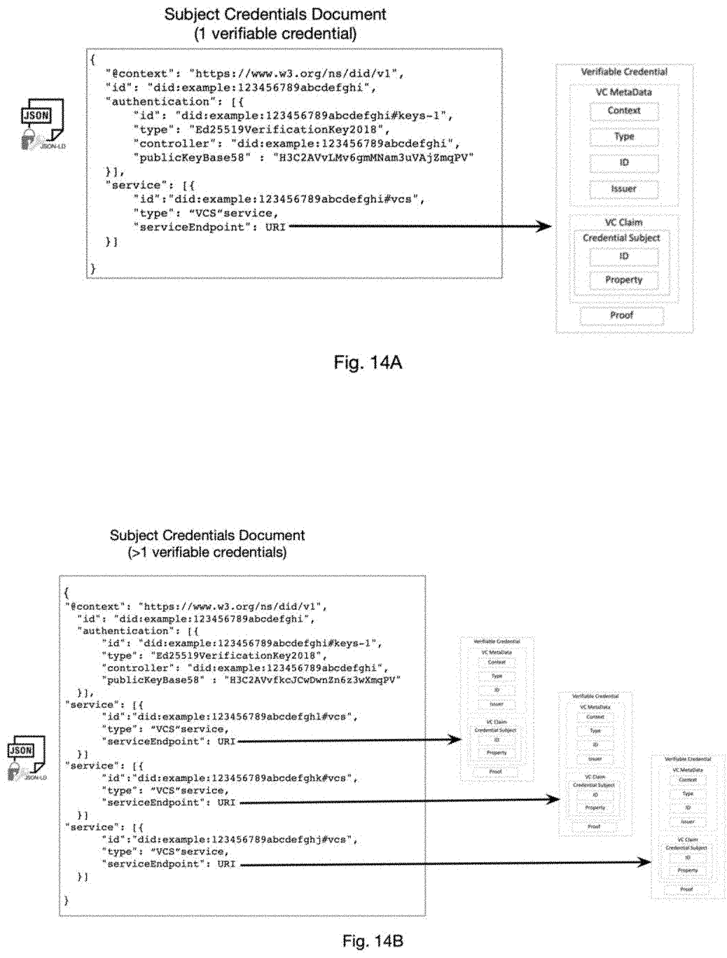

In the context of, e.g., step 1308 above, FIGS. 14A and 14B show a specific and technical exemplary structure, and corresponding logical organization, for a JSON-LD document including respectively a credentials document for one verifiable credential, and a credential document for a plurality of verifiable credentials.

FIG. 15 shows a process and system 1500 for retrieving PII under the control of a subject of the PII. The system 1500 includes receiving 1502 from a requester, by way of the subject of the PII, a public key of the requester, and receiving 1504 from a server-side privacy layer by way of the subject of the PII, a retrieval structure.

A private key 1506 of the PII subject and the public key of the PII requester are received at a subject side API which produces 1508 a single-use PII encryption 1510 of a previously stored encrypted PII document 1512. The previously stored encrypted PII is stored as an encrypted JSON-LD document in a data store controlled by the PII subject.

One exemplary embodiment of a PII record data structure 1514 includes a region 1516 for the storage of encrypted PII data as originally stored, and a further region 1518 for the storage of a single-use encrypted PII record embodying a re-encrypted previously encrypted PII. A retrieval pointer 1520 identifies the logical location of the further region 1518. A further region 1522 of the data structure 1514 provides functionality to revoke a share token for accessing the PII record data structure.

Once the encrypted JSON-LD document, embodying the PII record data structure 1514 has been prepared, a subject side API generates 1524 a single use access token. The resulting single use access token is then encrypted 1526 using the PII requester public key received via the PII subject, and the resulting encrypted token is delivered 1528 to the requester.

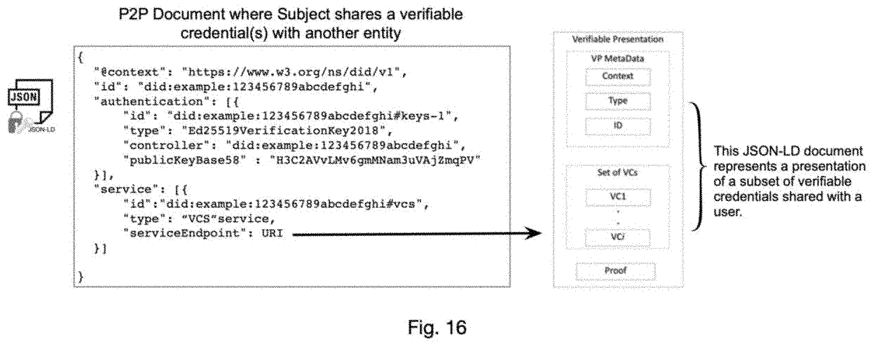

In the context of the foregoing, FIG. 16 shows a specific and technical exemplary structure, and corresponding logical organization, for a JSON-LD document including through a PII subject is empowered to share on a peer-to-peer basis one or more verifiable credentials with another entity. The illustrated JSON-LD document represents a presentation of a subset of verifiable credentials shared with the user/PII subject.

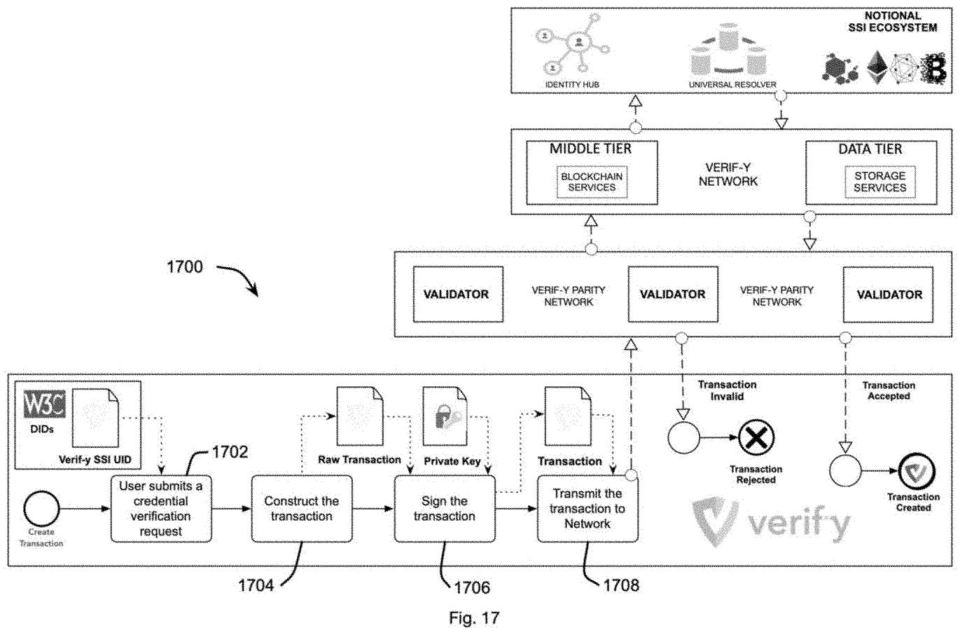

FIG. 17 illustrates specific technical details of further operative processes 1700 according to principles of the invention. These include a user submitting 1702 a credential verification request, construction of the corresponding transaction 1704, signing of the transaction 1706, and transmission of the transaction to the network 1708.

According to some embodiments, a method is performed at a computer system having one or more processors and memory storing one or more programs executed by the one or more processors. The method includes integration of blockchain into an off-chain storage solution supporting the removal of PII data and its inherent mutually exclusive ownership and support for re-permissioning access control mechanisms (for CRUD operations) of that data.

According to some embodiments, a method is performed at a computer system having one or more processors and memory storing one or more programs executed by the one or more processors. The method includes integration with a peer-to-peer (P2P) distributed file system (DFS) (e.g. InterPlanetary File System or IPFS), which includes functional layers to manage identity, network, routing, exchange (block distribution or shards), objects (content-addressable immutable objects links to the documents representing PII), and files with versioning, and naming (a mutable system for file/object identification). The method includes receiving a first data transmission from a client system including a document, the document using a hash key representing the object value and a unique identifier

Another embodiment of the invention might integrate a blockchain-based distributed ledger (DLT) system referring to storage systems that may contain blockchain properties (e.g. decentralization, byzantine fault tolerance, immutability, owner-controlled assets) with properties advantageous to distributed database systems (e.g. high transaction rate, low latency, indexing and querying of structured data) in order to address the concern of storing PH metadata in an immutable, privacy-preserving, and user-owned and accessed structure.

According to some embodiments, a method is performed at a computer system having one or more processors and memory storing one or more programs executed by the one or more processors. The method includes integration of one or more resilient registry infrastructures that support public validation of private data (e.g. PII in the form of identity credentials) without the need to directly store that data in the registry. An example of a resilient registry infrastructure blockchain-based storage system, which in the most general terms refers to storage systems that may contain blockchain properties (e.g. decentralization, byzantine fault tolerance, immutability, owner-controlled assets) with properties advantageous to distributed database systems (e.g. high transaction rate, low latency, indexing and querying of structured data) in order to address the concern of storing PII in an immutable structure.

According to some embodiments, a method is performed at a computer system having one or more processors and memory storing one or more programs executed by the one or more processors. The method includes a blockchain-based storage system can facilitate transactions re/assignment without exposing any concomitant PII data, assets, artifacts in the form of user-uploaded and or system-provided documents (e.g. PDF) and metadata. Certain embodiments of the present invention address the need for cryptographic pointers and or indirect referencing technologies, in order to help address concern of removing immutable transactions from the blockchain (i.e. the right to be forgotten). Alternatively, transactional data written to the blockchain may contain non-traceable references to PII data owned, managed, and stored for and by the user.

Certain embodiments of the present invention include, but are not limited to the integration of an isolated computing environment that includes a proxy service that facilitates the authoritative publishing of PII that is processed on behalf of a user, by an automated system, and pushed to the user-controlled, owned, and managed, storage and interface for accessing their PII. By integrating a non-volatile memory database Management System (DBMS) into an isolated compute environment, we reduce the need to delete information that is never stored on secondary storage to begin with. Additionally, it is important to note that this invention supports systems that are required to store PII in their back-end systems, only to be removed, after the PII has been used within transactions.

Another embodiment of the system adheres to SOPs where PII data (with the exception of rotating, non-human-readable, indirect cryptographic references) is not stored in an organization's back-end system, and instead uses an isolated system and in-memory database system (e.g. redis) to process PH without that PII being written to secondary storage (i.e. disk). In the latter case, an isolated system for processing PII may be integrated into a system (motivated by leveraging defense-in-depth strategies using cybersecurity best practices) in order to keep PII data as far away from enterprise infrastructures, including cloud service providers, as possible.

By integrating off-chain storage, users become the stewards of their data. Alternative embodiments of the invention include referencing PII, multi-signature participation in sharing data, key rotation, and user and group private key recovery (supporting n keys for a number of different), cryptographic techniques for encryption and decryption including but not limited to attribute-based encryption and key homomorphism. Multiple components orthogonal to the aforementioned technologies may be integrated into our off-chain storage solution.

To help illustrate the steps required for removing PII from a traditional centralized storage system, one might create a module that extracts PII from a centralized database (non-normative), thereby stripping the sensitive data at the atomic level as stored in a relational database management system (RDBMS) (e.g. MySQL DB) owned and controlled by the traditional information system (IS) to that of a user-owned storage system (e.g. one example is a blockchain-based database called BigchainDB).

In one instantiation of the system, an application programming interface (API) provides the functionality for querying existing PII database data resulting in saving the PH into JSON format with a specific naming convention: these datums require encryption, an interface for writing the encrypted files to a subsequent storage system such as IPFS—a protocol and peer-to-peer network for storing and sharing data in a distributed file system, with content-addressing to uniquely identify each file in a global namespace connecting all computing devices within the cloud storage infrastructure, or IPFS.

Additionally, interfaces in the form of accessible and published APIs are required by the systems that integrate the off-chain storage solution for writing and differentiating data that is validated and authentic (e.g. credentials using primary source verification). Certain embodiments of the present invention include, but are not limited to, a system that stores, albeit temporarily, PII in centralized data storage systems, that after performing business services, needs to be removed from these storage systems (an audit log is required to assure that all PII—with the exception of indirect references—has been removed from all storage systems). In one embodiment, one might record cryptographic hash values representing the state or value of PII data including viewing the PII as HTML pages.

Another example of extraction of PII might choose to implement a blockchain layer for storing file hashes to compare and correlate the value of the PII with the authoring system which published the PII to begin with. In another embodiment of this invention, we operate by integrating a blockchain-based database where an interface provides a read of pending file hashes written to a permissioned blockchain network.

After removing PII from a centralized back-end storage system and inserting the user-controlled, owned, and managed data into a distributed storage system, users are able to interact with their data just as if the data was stored on a traditional IS. However, this invention enables a reduction in the risk of data theft. For example, once a record is processed from a backend IS and pushed to the cloud-based decentralized storage system, the user will have exclusive ownership, and will be able to view and interact with the underlying PII using published interfaces (e.g. credential wallet application).

An example client might need the ability to safely process, store, and submit PII in the form of attestations representing authoritative (primary source verification) of work experience, education, and other credential records. Upon selecting a record, the APT could retrieve a decentralized identifier (DID) from a blockchain using the required credentials: the IPFS is queried (on behalf of the user) for the file hash that matches the DID, after which, an asset is returned by IPFS, decrypted, and the JSON file processed and displayed on the HTML page.

Note that in an example instantiation, an HTML page can be substituted for a model view controller (MVC) user interface (UI), such as a credential wallet application, native, and web-based applications.

In various further embodiments, the present invention includes an off-chain storage solution (privacy Layer) to securely store personally identifiable information (PII) in user managed and controlled encrypted data vaults. The privacy layer facilitates the storage and retrieval of user credential records via application programming interfaces (APIs) from data stored on decentralized cloud storage.

One deployment topology according to principles of the invention includes storing encrypted PII on users' mobile devices (holders) which is synchronized with user encrypted data vaults. To facilitate interoperability, certain embodiments of the invention will rely on the W3C decentralized identifiers (DIDs), verifiable credentials (VCs), JSON-LD, and although early in its development, we have participated in the Secure Data Stores W3C CCG & DIF joint working group.

In certain embodiments, a Credential and Employment Verification (C&EV) Platform will facilitate the issuance and verification of educational, work experience, certificates, and license credentials. Accordingly an exemplary C&EV Platform operates on a pluggable extensible architectural framework supporting layered functionality such as compliance screening and self-sovereign identity (SSI) services and standards.

Further embodiments of the invention will include interfaces via a mobile and web applications for credential Holders to interface with their credential wallet, and software as a service (SaaS) dashboards for Issuers. Issuers can also use APIs for credential issuance and registration. Accordingly, the subject of PII is able to own and control his or her data. In certain conventional systems, PII is stored in a compliant centralized data store. The present invention offers, in its various embodiments, user ownership and control of credential data. In certain embodiments, a system according to the invention includes a blockchain integrated off-chain storage solution (referred to as a privacy layer).

Exemplary embodiments of the invention onboard issuers via a Software as a Service (SaaS) dashboard and or through APIs for submitting and validating credentials. Credentials that enter the platform are verified and validated through connecting credential requests to Holders with the appropriate Issuers.

While the exemplary embodiments described above have been chosen primarily from the field of identity and credentials validation, one of skill in the art will appreciate that the principles of the invention are equally well applied, and that the benefits of the present invention are equally well realized in a wide variety of other data systems including, for example, the storage and management of educational, employment and service records.

Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A method of storing personally identifiable information comprising:
allowing is subject to register with an application;
generating a private encryption key and a public encryption key for said subject;
issuing from said application said public key to a registrar service;
receiving at the application a digital identity from said registrar service;
creating a document and associating said document with said digital identity;
storing said document in a ledger; storing said private key and said public key in a key management system;
allocating storage in a repository controlled by a subject of said personally identifiable information;
receiving said personally identifiable information from an originating entity;
validating said personally identifiable information;
applying a one-directional validation hash to said personally identifiable information to produce hashed personally identifiable information; and
storing said personally identifiable information in said repository.
